(19) United States
(12) Patent Application Publication
(10) Pub. No.: US 2020/0216149 A1
(43) Pub. Date: Jul. 9, 2020

(54) EQUIPMENT FOR PRODUCING A FLOATING PHOTOVOLTAIC INSTALLATION

(71) Applicant: CIEL ET TERRE INTERNATIONAL, SAINGHIN EN MELANTOIS (FR)

(72) Inventor: Alexis GAVEAU, VILLENEUVE D'ASCQ (FR)

(73) Assignee: CIEL ET TERRE INTERNATIONAL, SAINGHIN EN MELANTOIS (FR)

(21) Appl. No.: 16/648,070

(22) PCT Filed: Sep. 17, 2018
(86) PCT No.: PCT/FR2018/052271

§ 371 Date: Mar. 17, 2020

(30) Foreign Application Priority Data
Sep. 18, 2017 (FR) 1758637

(51) Int. Cl. B63B 35/44; B63B 35/38; B63B 75/00; H02S 20/30; H02S 30/10

(52) U.S. Cl. CPC B63B 35/44; B63B 35/38; B63B 2035/4453; H02S 20/30; H02S 30/10; B63B 75/00

(57) ABSTRACT

An item of equipment for producing a floating photovoltaic installation, of modular design, which includes float modules constituted, in whole or in part, of plastic casings, confining an air volume, having a neck with an opening, blocked by a stopper, structural modules, support elements, and possibly, connecting modules. The structural modules and/or the connecting modules include lugs intended to face one another for the assembly of the modules, and wherein the float modules are configured such that the assembly of the lugs facing one another is obtained, in whole or in part, by inserting the neck through the lugs, the stopper not present, then locking the assembly by the placing of the stopper blocking the opening of the neck.

The invention relates to an item of equipment for producing a floating photovoltaic installation, of modular design, as well as a photovoltaic installation resulting from the assembly of the modules of the equipment.

The field of the invention is that of floating photovoltaic installations, and more specifically, floating photovoltaic installations resulting from the assembly of floating devices, panel support, of modular design.

Such modular devices can be assembled onsite, by aligning the photovoltaic panels of one same row, and often by constituting several rows of photovoltaic panels.

The state of the art knows, for example, from document US 2008/0029148 A1, an installation resulting from the assembly of panel-supporting floating devices, of modular design.

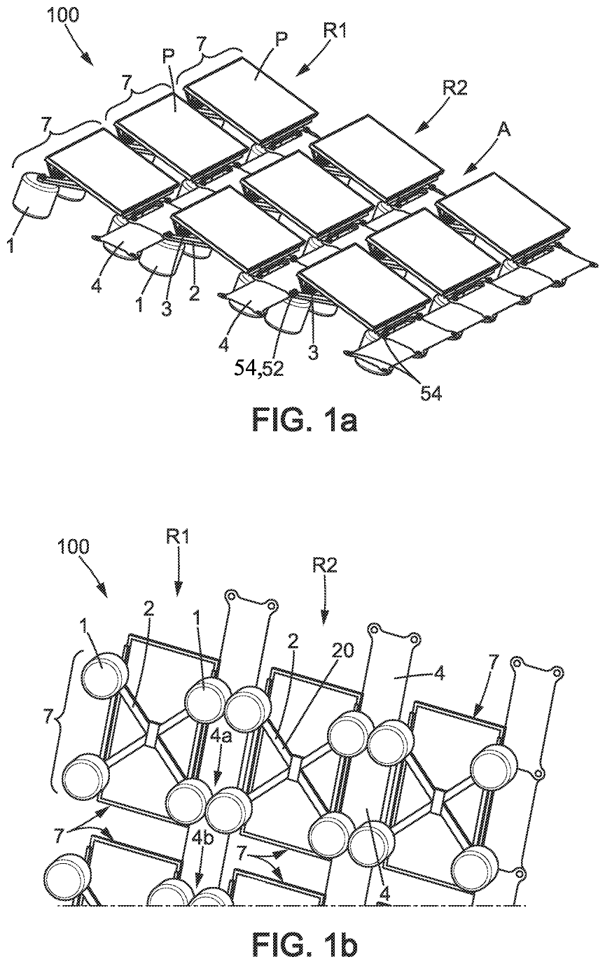

Each modular floating device, such as illustrated in FIG. 1 of this prior art, comprises two extended, cylindrical floats, as well as a self-supporting structure resulting from an assembly of tubes welded together. Four tubes of the structure extend longitudinally, respectively, in the extension of the ends of the floats, the terminal ends of these tubes being provided with end rings. The assembly of the floating photovoltaic installation is obtained, along the direction of the extended floats, by the direct coupling of the end rings of a floating device to the end rings of an adjacent modular device.

The floating device comprises four other additional lateral coupling rings, to ensure the assembly of the floating devices in the vicinity, along the perpendicular direction.

The assembly of the floating photovoltaic installation is obtained, along the direction perpendicular to the extended floats, by the coupling of the lateral rings of a floating device to the lateral rings of an adjacent modular device, by way of connecting parts.

This structure makes it possible to support two photovoltaic panels, mounted rotating with respect to the structure.

Manufacturing such devices, taught by this prior art, requires the production of a structure resulting from the assembly of tubes, typically a mechanically welded assembly. According to the observations of the inventor, such a design is not economically useful, through the manufacturing cost thereof, which is too high.

A person skilled in the art also knows from document WO2012/139998, an installation resulting from the assembly of floating devices, panel supports, of modular design and of connecting modules, themselves in the form of floats. The support devices and the connecting modules are intended to be assembled to form a network of floats.

According to this modular design, each modular panel support device is constituted mainly of a plastic casing which supports several functions and, in particular:
a float function: the plastic casing confines, in a sealed manner, an air volume making it possible to ensure the floating of the device,
possibly, an element function to incline the photovoltaic panel: the upper wall thereof is inclined with respect to the lower wall thereof so as to ensure the inclination of the photovoltaic panel with respect to the water body, and
a structural element function: the plastic casing constitutes the structure by which the network of floats is passed through by forces.

The multifunctional plastic casing of this modular device is typically obtained by blown extrusion, of one single support, which reduces the costs with respect to the mechanically welded structure of the device of document US 2008/0029148 A1.

A person skilled in the art also knows, from document WO2011/094803, an installation resulting from the assembly of floating devices, panel supports, of modular design, assembled directly together to constitute a network of floats.

According to this modular design, each device comprises a float, it appears constituted by a casing, and supports making it possible to incline the photovoltaic panel with respect to the float.

The casing forms coupling elements, referenced 16 to 22 which make it possible for the assembly together of floats.

The casing supports several functions, namely:
a float function, and
an intermediate structural function: the casing constitutes the structure by which the network of floats is passed through by forces.

The function of inclining the panel with respect to the surface of the water is ensured by separate elements of the floats.

In documents WO2012/139998 or also WO2011/094803, the casing must be sufficiently resistant to make it possible to resist the forces of the network. According to the observations of the inventor, it is necessary, in practice, to increase the resistance of this element by providing a thickness of the upper wall to that which would be necessary to only ensure the float function.

The blown extrusion of a plastic casing, of a complex shape, such as taught by document WO2012/139998 can be achieved and has been manufactured by the applicant. However, it requires, from the plasturgist manufacturer, a significant knowhow, in order to have sufficient thickness of material there where this proves to be necessary, while limiting the plastic consumption.

According to the observations of the inventors, another disadvantage of the devices of documents WO2012/139998 and WO2011/094803 is that of the transport on the site of placing the constituting elements thereof, and in particular, float elements, semi-rigid or rigid parts, which are of significant bulk.

Also, document WO 2015/092237 is known from the present applicant, which relates to a floating photovoltaic panel support device, comprising:
a structure comprising elements for coupling to other floating devices so as to make it possible for the formation of a network of floating devices,
one or more floats, intended to ensure the floating of the device, integral with said structure,
elements for maintaining at least one photovoltaic panel.

Notably, said structure is a separate element of the or of said floats so as to make it possible for the transmission of the forces between the floating devices of the network, without transmitting the forces from the network to said float(s). It is thus possible to size the or each of the floats, formed by a casing of low wall thickness.

In this prior art, the floats and the structure are plastic parts which can be manufactured at a lower cost and be assembly quickly onsite, advantageously without any hoisting means. The float(s) are assembled on the under-face of the structure by any suitable means, and preferably removably. The different modular elements constituting the device can be of reduced bulk during transport, and by comparison, to the devices of documents WO2012/139998 and WO2011/094803 which are of significant bulk. Document WO 2015/092237 also describes an item of equipment for producing a photovoltaic installation comprising several modular devices capable of being assembled to form a floating device network. These floating devices can be assembled directly together, or by way of connecting module. The assembly is typically obtained by the coupling elements, in the form of protruding lugs, facing one another, the locking obtained by dedicated members such as a bolt or pins, passing through the lugs.

The aim of the present invention is to overcome the abovementioned disadvantages by proposing an item of equipment, of modular design, of low cost price for producing a floating photovoltaic installation, which is of modest bulk when disassembled comparatively with the equipment of the prior art WO2012/139998 and WO2011/094803, and of which the onsite assembly is simplified with respect to the equipment disclosed by document WO 2015/092237.

Another aim of the present invention is to propose an installation resulting from the assembly of the modules of the equipment.

Another aim of the present invention is to propose a method for manufacturing such an item of equipment, even such an installation.

Other aims and advantages of the present invention will appear during the description which is only given for information purposes and which does not aim to limit it.

Also, the invention relates to an item of equipment for producing a floating photovoltaic installation, of modular design, comprising:
float modules, and
structural modules,
support elements, intended to bear on the structural modules to maintain photovoltaic panels,
possibly, connecting modules,

said structural modules and said float modules being configured to be assembled in order to produce a floating network of floating panel devices, the structural modules being supported by the float modules, the structure ensuring the transmission of forces from the network of panel support devices resulting from the assembly of structural modules, directly together, and/or by way of connecting modules.

According to the Invention:
the float modules are constituted in whole or in part by plastic casings, confining an air volume, having a neck with an opening, blocked by a stopper,
the structural modules and/or the connecting modules comprise lugs intended to face one another for the assembly of structural modules together, directly, or by way of connecting modules,

and wherein the float modules are configured such that the assembly of the lugs facing one another is obtained, in whole or in part, by inserting the neck through the lugs, the stopper not present, then locking the assembly by the placing of the stopper blocking the opening of the neck.

Once the stopper is locked, the lugs are maintained between two abutments formed by a shoulder at the base of the neck and a shoulder of the stopper.

According to optional features of the invention, taken individually or in combination:
the lugs are intended to be substantially horizontal when the installation rests on a horizontal surface, the axis of the neck thus substantially vertically;
the plastic casing of each float module is likely to be obtained by blowing injection, or also blown extrusion;
once the stopper is locked, the gap between the two shoulders formed between the stopper and the neck ensures a clearance between the lugs passed through by the neck, along the direction of the axis of the neck;
a circular flexible seal bears between the lugs passed through by the neck;
the stopper is a stopper screwed on the neck;
the stopper is a stopper configured to be externally mounted to the neck, or alternatively, the stopper is a stopper configured to be internally mounted to the neck;
the wall of the plastic casing of the float module is of average thickness less than 2 mm, even less than 1 mm, all of the plastic casing, or also on the portion of the plastic casing, except for the neck;
the thickness of the wall of the neck is greater than the average wall thickness on the remainder of the plastic casing;
the stopper has a reinforcing portion extending to the level of the lugs, the thickness greater than the wall thickness of the neck;
the reinforcing portion of the stopper penetrate the neck, and has a peripheral surface bearing on the inner wall of said neck, at least at the level of the lugs;
the equipment has a reinforcing sleeve, passed through by the neck, separate from the stopper inserted between the lugs and the neck, possibly between the stopper and the lugs, said reinforcing sleeve being intended to support the shearing forces of the lugs: this reinforcing sleeve is thus configured so as to support the shearing forces of the lugs, advantageously without transmitting these forces to the neck;
the lugs passed through by the neck have complementary male/female conformations, configured to be intertwined during the assembly, in order to ensure the transmission of the shearing forces of the lugs directly together;
the stopper and/or also the reinforcing sleeve can be made of plastic reinforced with fibres, such as for example, polyamide reinforced with glass fibres, or also polypropylene reinforced with glass fibres,
the reinforcing sleeve is made of metal.

The invention also relates to a floating photovoltaic installation resulting from the assembly of the equipment according to the invention, and wherein:
said structural modules and said float modules are assembled in order to produce a floating network of panel support devices, the structural modules being supported by the float modules, the structure ensuring the transmission of the forces of the floating network of panel support devices resulting from the assembly of structural modules, directly together and/or by way of connecting modules,
the assembly of the lugs facing one another is obtained, in whole or in part, by inserting the neck through the lugs, the stopper ensuring the locking of the assembly: the lugs are maintained between two abutments formed by said shoulder at the base of the neck and said shoulder of the stopper.

According to optional features, taken individually or in combination:
the structure of the network results at least partially from the assembly of the modules by way of connecting modules, ensuring the transmission of forces of the network of the floating devices and wherein the connecting modules form a maintenance path between two rows of photovoltaic panel support devices;
the connecting modules forming a maintenance path are configured to brace the photovoltaic panel support floating devices belonging to one same row by creating interspaces between the devices, the photovoltaic panels supported by the panel support floating devices being provided as full, the full portions of the photovoltaic panels extending above said interspaces,
the connecting modules are floating, for example in the form of a blown-extruded plastic casing.

The invention also relates to a method for manufacturing an item of equipment according to the invention, or also an installation according to the invention, wherein float modules are manufactured by blown injection.

The invention will be better understood upon reading the following description, accompanied by appended drawings, among which:

FIG. 1a is a perspective view of an installation resulting from the assembly of modules of an item of equipment according to the invention according to a first embodiment for which the structure ensuring the transmission of the forces of the network of panel support devices results from the assembly of structural modules by way of connecting modules,

FIG. 1b is a bottom view of the installation such as illustrated in FIG. 1,

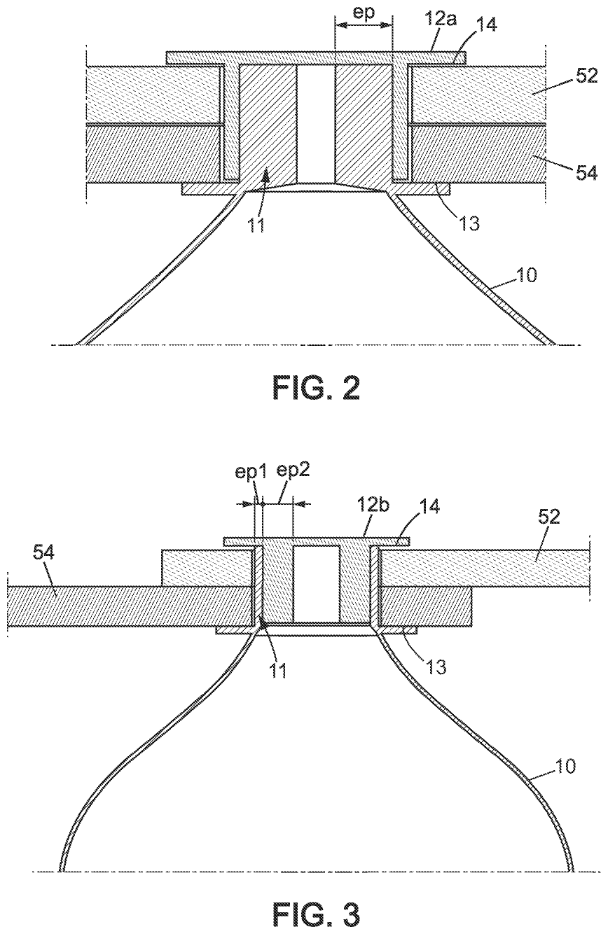

FIGS. 2 to 5 represent various embodiments of the assembly of the lugs which is advantageously obtained thanks to the neck and to the stopper of the float module,

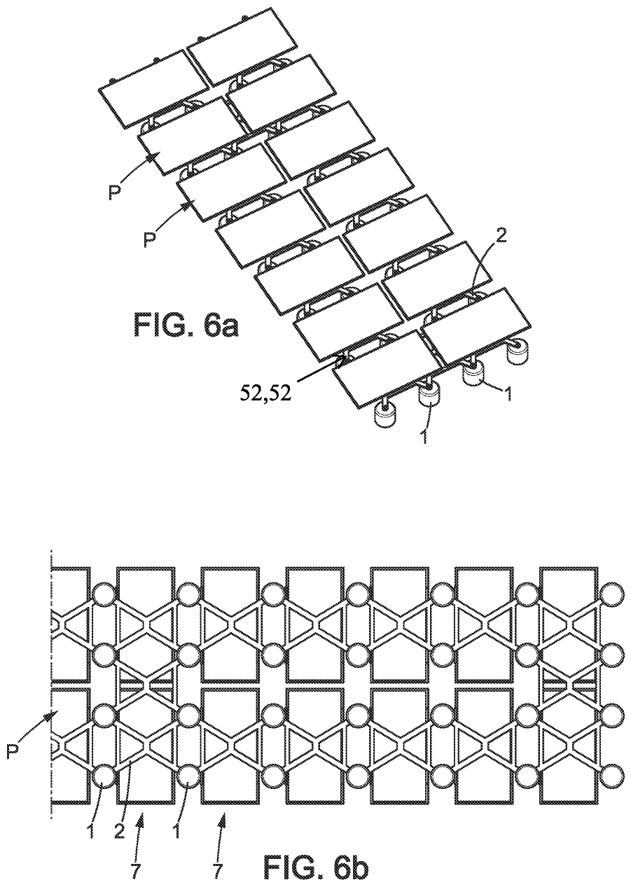

FIGS. 6a and 6b are top and bottom views of an installation according to a second embodiment for which the structure ensuring the transmission of the forces of the network of the panel support devices results from the assembly of structural modules, directly together,

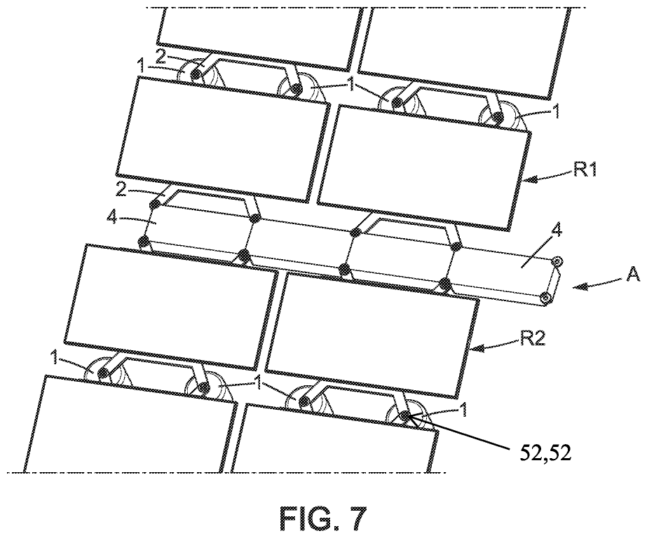

FIG. 7 is a top view of an installation according to a third embodiment for which the structure ensuring the transmission of the forces of the floating network of panel support devices results from the assembly of structural modules, some directly together, and others by way of connecting modules, the connecting modules being floating.

Also, the invention relates to an item of equipment for producing a floating photovoltaic installation, of modular design, comprising:
float modules 1, and
structural modules 2,
support elements 3, intended to be born on the structural modules to maintain photovoltaic panels P,
possibly, connecting modules 4.

Said structural modules 2 and said float modules 1 are configured to be assembled in order to produce a floating network of panel support devices 7, the structural modules 2 being supported by the float modules.

The structure of the network ensuring the transmission of the forces of the network of panel support devices 7 results from the assembly of structural modules 2, directly together (see FIGS. 6a and 6b), or also by way of connecting modules 4 (see FIGS. 1a and 1b). According to another embodiment (see FIG. 7), the structure of the network results from the assembly of structural modules 2, some directly together, and other by way of connecting modules 4.

The float modules 1, the structural modules 2, even the support elements 3 and, if necessary, the connecting modules 4 are preferably plastic elements which can be easily obtained and at a lower cost by moulding techniques, and in particular:
the float modules can be plastic parts obtained typically by blown injection, or also blown extrusion,
the structural modules can be constituted, each of a plastic part obtained by moulded injection, or the assembly of several plastic parts obtained by moulded injection, or also pultrusion,
the connecting modules 4 can be moulded, in particular by blown extrusion and be floating.

Moreover, and according to the invention:
the float modules 1 are each constituted, in whole or in part, of plastic casings each confining an air volume, having a neck 11 with an opening, blocked by a stopper 12a; 12b; 12c, 12d,
the structural modules 2 and/or the connecting modules 4 comprise lugs 52, 54 intended to face one another for the assembly of structural modules 2 together, directly or indirectly by way of connecting modules 4.

The lugs 52 are produced, for example, of one single support with the plastic part(s) constituting the structural module 2. According to an alternative, the lugs can be perforated after moulding (or pultrusion) to the body of the structure.

Notably, and according to the invention, the float modules 1 are configured such that the assembly of the lugs 52, 52; 52, 54 facing one another is obtained by inserting the neck 11 of the plastic casing 10 through the lugs 52, 54 to be assembled (the stopper thus not present, in particular removed), then locking the assembly by the placing of the stopper 12a; 12b; 12c, 12d blocking the opening of the neck 11.

Thus, and according to the invention, the float module 1 not only supports a first function to ensure the floating of panel support floating devices 7 of the installation, but also advantageously combines a locking key function for the assembly of the lugs 52, 52; 52, 54 together.

During one same assembly, it is noted that not only the coupling of the lugs 52, 52 belonging to the structural modules 2 is obtained (FIGS. 6a and 6b or FIG. 7), or also the coupling of the lugs 52, 54 belonging respectively to the structural module 2 and to said connecting module 4 (FIGS. 1a and 1b), but also advantageously the fixing of the float module 1 to the structural module 2 of the support device 7.

According to another embodiment (not illustrated), the neck 11 of the float module can also make it possible to connect a lug 52 of the structural module 2, and a ring belonging to a means configured for the anchoring of the floating network of photovoltaic panel support devices. In such a case, the lug 52 and the ring are passed through by the neck and locked together by the stopper.

There can be two, even three, or also four lugs assembled by one same float, i.e. passed through by the neck 11. It is noted that the lugs 52, 54 are intended to be substantially horizontal when the installation rests on a horizontal surface, the axis of the neck 11 of the float modules thus being substantially vertical.

The plastic casing can be presented in the form of a hollow body, for example mainly cylindrical, having the neck 11.

Advantageously, the plastic casing 10 of each float module 1 is likely to be obtained by blown injection or also by blown extrusion.

Once the stopper is locked, the lugs 52; 54 are maintained between two abutments formed, in particular by a shoulder 13 at the base of the neck 11 and a shoulder 14 of the stopper 12a; 12b; 12c; 12d. The shoulder 13 at the base of the neck 11 can be obtained during the moulding of the float module 1.

Once the stopper is locked 12a; 12b; 12c; 12d, the gap between the two shoulders 13, 14 formed between the stopper and the neck can possibly ensure the presence of a clearance between the lugs 52; 54 passed through by the neck 11, along the direction of the axis of the neck 11. Such a clearance facilitates the mounting, in that the stopper can be systematically abutted on the neck, during the fixing thereof, for example by screwing.

Possibly, a circular flexible seal can bear between the lugs passed through by the neck in order to fill the clearance.

The lugs are preferably flexible so as to enable that the structure of the network is deformed with the swell.

According to an embodiment, the stopper 12a; 12b, 12c, 12d can be a stopper screwed on the neck: according to this embodiment, the stopper and the neck respectively have screw threads, mutually engaging by screwing.

It is understood that other fixing methods can be considered to secure the stopper to the neck, such as:

Gluing

Clipping

Welding

Pinning

Force-mounting.

According to a possibility illustrated in the examples of FIGS. 2, 4 and 5, the stopper 12a, 12c, 12d can be a stopper configured to be externally mounted to the neck 11. Alternatively, and according to another possibility illustrated in FIG. 3, the stopper 12b is a stopper configured to be internally mounted to the neck 11.

The lugs 52, 54 passed through by the neck 11 ensure the transmission of the forces of the network of panel support devices: advantageously different arrangements can be provided in order to ensure the resistance of the assembly to the shearing forces transmitted by the network of support devices.

The plastic casing forming each float module 1 can be of average, relatively thin thickness, in particular less than 3 mm, preferably less than 2 mm, even less than 1 mm, in that it does not transmit the forces of the network of devices, except for the neck, according to an embodiment.

Thus, the wall of the plastic casing of the float module 1 is, according to an embodiment, of average thickness less than 2 mm, all of the plastic casing, or also on the portion of the plastic casing except for the neck 11.

According to a first possibility illustrated in FIG. 2, the wall thickness ep of the neck 11 can be reinforced: the wall thickness ep of the neck is thus greater than the average wall thickness over the remainder of the plastic casing and in order to resist the shearing forces of the lugs. It will be noted that this reinforcement is local, at the level of the neck 11 only of the float module: the wall thickness can remain thin (less than or equal to 3 mm, even less than 2 mm, even less than 1 mm) over the remainder of the plastic casing with a float function. The thickness ep at the level of the neck 11 can be greater than 3 mm, even greater than 4 mm or 5 mm.

According to a possibility illustrated in FIG. 3, the stopper 12b can also have a reinforcing portion extending to the level of the lugs, of thickness ep2 greater than the wall thickness ep3 of the neck, and likely to support at least in part, the shearing forces exerted by the lugs 52, 54 on the neck 11.

For example, in FIG. 3, the reinforcing portion of the stopper 12b penetrates the neck 11, and has a peripheral surface bearing on the inner wall of said neck 11, at least at the level of the lugs 52, 54. According to this example, the wall thickness of the plastic casing 10 can remain thin (less than 3 mm, even less than 2 mm), even at the level of the neck. The thickness ep2 of the reinforcing portion of the stopper can be greater than 3 mm, even greater than 4 mm, while the neck wall thickness ep3 is less than or equal to 3 mm.

According to another possibility which can be used by itself, or in combination with the preceding solutions, a reinforcing sleeve 15 (separate from the stopper 12c ) is passed through by the neck 11. This sleeve 15 is advantageously inserted between the lugs 52, 54 and the neck 11, possibly between the stopper 12c and the lugs 52, 54. This reinforcing sleeve 13 is intended to support the shearing forces transmitted by the lugs 52, 54, by avoiding the transfer thereof to the neck 11.

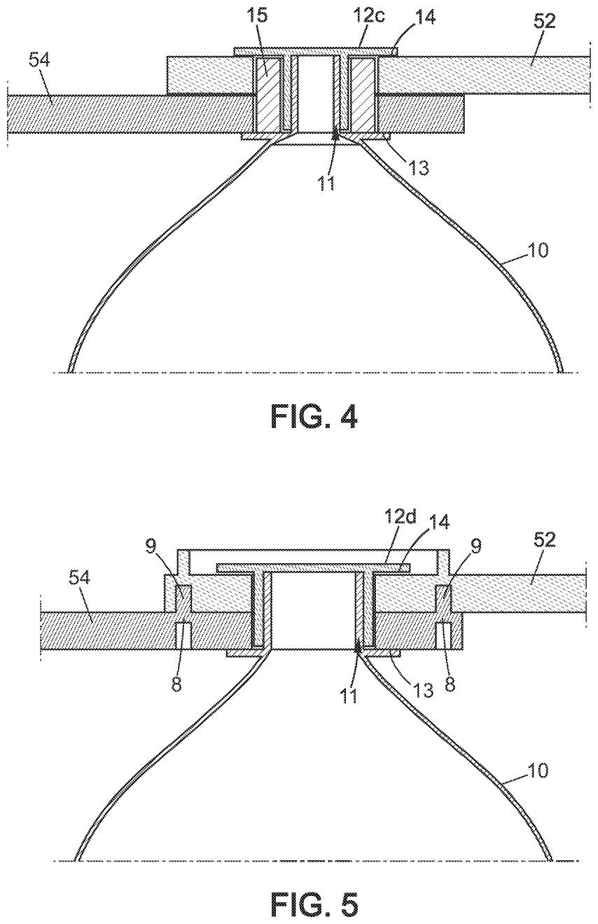

Also, according to another possibility illustrated in FIG. 5, the lugs 52, 54 passed through by the neck 11 can have complementary male/female conformations 8, 9, configured to be intertwined during the assembly of the lugs in order to ensure the transmission of shearing forces of the lugs 52, 54 directly together, i.e. without transmitting these forces to the neck 11, even to the stopper 12d. These conformations 8, 9, when intertwined forbid a relative sliding between the lugs 52, 54. The locking of the stopper 12d on the neck 11 advantageously prevents the lugs 52, 54 from being deviated from one another by a sufficient amplitude to clear the conformations 8, 9: thus, the conformations 8, 9 are maintained mutually engaged. Once the stopper is removed, the lugs 52, 54 can be removed from the neck 11, and deviated from one another by a sufficient amplitude to clear the conformations 8, 9 and makes it possible for the separation of the lugs 52, 54.

According to an embodiment, the stopper 12a, 12b, 12c, 12d, and/or also the reinforcing sleeve 15 of the equipment can be made of plastic reinforced with fibres, such as, for example polyamide reinforced with glass fibres, or also polypropylene reinforced with glass fibres. The reinforcing sleeve 15 can also be a metal sleeve. The float module 1 can be made of high-density polyethylene (HDPE) or poly(ethylene terephthalate) (PET).

According to an embodiment illustrated in the figures as a non-limiting example, said structural module 2 is a cross 20 of which the two branches are each terminated by lugs 52 at the ends thereof. The cross can be constituted by a plastic element moulded with one single support, or also the grouping and the assembly of two V-shaped plastic elements.

According to an embodiment illustrated in FIGS. 1a and 1b, the panel support device 7 thus comprises four float modules 1 respectively integral with the four ends of the cross. A support element 3 is integral with the upper surface to ensure the maintenance of the photovoltaic panel P. This support element 3 can also make it possible to incline the photovoltaic panel P with respect to the horizontal main plane of the structural module 2, for example of an angle of between 5° and 30°, even more.

According to this embodiment, the panel support devices 7 are assembled indirectly together by way of connecting modules 4. This connecting module can be a plastic element, for example substantially rectangular which comprises lugs 54 at the four corners thereof.

According to the embodiment illustrated, the connecting modules 4 form a maintenance path A between two rows R1, R2 of photovoltaic panel support devices 7. According to this embodiment, two of the lugs 54 of said connecting module 4a located on one same side can be assembled to the two lugs 52 of the structural module 2 of one same panel support device 7 belonging to the row R1, the two lugs 54 located on the other side being assembled to the two consecutive lugs 52 of a structural module 2 of a panel support device belonging to the row R2.

The consecutive connecting module 4 belonging to the same maintenance path A can be used to brace two consecutive support devices 7 belonging to one same row R1 or R2, by creating an interspace together. Thus, it is noted that the photovoltaic panels P can be full of the devices 7, the full portions of the panels extending above the interspaces between devices 7.

Thus, it is noted that the connecting module 4b consecutive to that referenced 4a is used for this bracing: it has, on the side of the row R1, two lugs 54 assembled respectively to two consecutive support devices 7 of the row R1, and two lugs 54 assembled respectively to two consecutive support devices 7 of the row R2.

The embodiment of FIGS. 6a and 6b are distinguished from that of FIG. 1a and 1b in that the structural modules 2 are assembled directly together, the lugs belonging to two structural modules 2 of two support devices 7 respectively facing one another. The assembly thereof is obtained by inserting the neck 11, then fixing the stopper on the neck in order to lock the lugs.

The embodiment of FIG. 7 is distinguished from the two preceding embodiments in that some of the lugs of the structural modules are connected to lugs belonging to floating connecting modules, for example in the form of a blown-extruded plastic casing. Such connecting modules belonging to an excess floating are used, when these elements are used as a maintenance path. The lugs facing one another belonging to the connecting module and to the structural module are assembled by fixing members such as pins or a screw/nut system, passing through the lugs.

### NOMENCLATURE

1. Float modules,
10. Plastic casing,
11. Neck,
12a, 12b, 12c, 12d. Stoppers,
2. Structural modules,
20. Cross,
3. Support elements,
4. Connecting modules,
4a, 4b. Consecutive connecting modules (see FIG. 1b)
52, 54. Lugs (assembly) belonging to the structural modules and to the connecting module,
7. Panel support floating devices,
8,9. Male/female conformations ensuring the direct transmission of forces between the lugs,
13, 14. Shoulders formed at the base of the neck and on the stopper,
15. Reinforcing sleeve,
P. Photovoltaic panels,
100. Installation.

1-20. (canceled)

21. An equipment for producing a floating photovoltaic installation, of modular design, comprising:
float modules, and
structural modules,
support elements, intended to bear on the structural modules to maintain photovoltaic panels,
possibly, connecting modules, said structural modules and said float modules being configured to be assembled in order to produce a floating network of panel support devices, the structural modules being supported by the float modules, the structure ensuring the transmission of forces of the floating network of panel support devices resulting from the assembly of structural modules , directly together, and/or by way of connecting modules,
wherein:
the float modules are constituted, in whole or in part, of plastic casings, confining an air volume, having a neck with an opening, blocked by a stopper,
the structural modules and/or the connecting modules comprise lugs intended to face one another for the assembly of structural modules together, directly or by way of connecting modules, and
the float modules are configured such that the assembly of the lugs facing one another is obtained, in whole or in part, by inserting the neck through the lugs, the stopper not present, then locking the assembly by the placing of the stopper blocking the opening of the neck and wherein once the stopper is locked, the lugs are maintained between two abutments formed by a shoulder at the base of the neck and a shoulder of the stopper.

22. The equipment according to claim 21, wherein the lugs are intended to be substantially horizontal when the installation rests on a horizontal surface, the axis of the neck thus substantially vertically.

23. The equipment according to claim 21, wherein the plastic casing of each float module is likely to be obtained by blown injection or also blown extrusion.

24. The equipment according to claim 21, wherein once the stopper is locked, the gap between the two items of equipment formed between the stopper and the neck ensures a clearance between the lugs passed through by the neck, along the direction of the axis of the neck.

25. The equipment according to claim 24, wherein a circular flexible seal is born between the lugs passed through by the neck in order to fill the clearance.

26. The equipment according to claim 21, wherein the stopper is a stopper screwed on the neck.

27. The equipment according to claim 21, wherein the stopper is a stopper configured to be externally mounted to the neck.

28. The equipment according to claim 21, wherein the stopper is a stopper configured to be internally mounted to the neck.

29. The equipment according to claim 21, wherein the wall of the plastic casing of the float module is of average thickness less than 2 mm, even less than 1 mm, all of the plastic casing, or also on the portion of the plastic casing except for the neck.

30. The equipment according to claim 21, wherein the wall thickness of the neck is greater than the average wall thickness over the remainder of the plastic casing.

31. The equipment according to claim 21, wherein the stopper has a reinforcing portion extending to the level of the lugs, of thickness greater than the wall thickness of the neck.

32. The equipment according to claim 21, wherein the reinforcing portion of the stopper penetrates the neck, and has a peripheral surface bearing on the inner wall of said neck, at least at the level of the lugs.

33. The equipment according to claim 21, having a reinforcing sleeve, passed through by the neck, separate from the stopper inserted between the lugs and the neck, possibly between the stopper and the lugs, said reinforcing sleeve being configured so as to support the shearing forces of the lugs without transmitting these forces to the neck.

34. The equipment according to claim 21, wherein the lugs passed through by the neck having complementary male/female conformations, configured to be intertwined during the assembly, in order to ensure the transmission of the shearing forces of the lugs directly together.

35. The equipment according to claim 21, wherein the stopper, and/or also a reinforcing sleeve passed through by the neck, separate from the stopper inserted between the lugs and the neck, possibly between the stopper and the lugs, said reinforcing sleeve being configured so as to support the shearing forces of the lugs without transmitting these forces to the neck, are made of plastic reinforced with fibres, such as for example, polyamide reinforced with glass fibres, or also polypropylene reinforced with glass fibres, or also the reinforcing sleeve is made of metal.

36. A floating photovoltaic installation resulting from an assembly of the equipment according to claim 21, and wherein:
said structural modules and said float modules are assembled in order to produce a floating network of photovoltaic panel support devices, the structural modules being supported by the float modules, the structure ensuring the transmission of the forces of the floating network of the photovoltaic panel support devices resulting from the assembly of structural modules, directly together, and/or by way of connecting modules,
the assembly of the lugs facing one another is obtained, in whole or in part, by inserting the neck through the lugs, the stopper ensuring the locking of the assembly, the lugs being maintained between two abutments formed by said shoulder at the base of the neck and said shoulder of the stopper.

37. The installation according to claim 36, wherein the structure of the network results from the assembly of structural modules by way of connecting modules, ensuring the transmission of the forces of the floating network of the panel support devices, and wherein the connecting modules form a maintenance path between two rows of photovoltaic panel support devices.

38. The installation according to claim 37, wherein the connecting modules forming a maintenance path are configured to brace the panel support floating devices belonging to one same row, by creating interspaces between the devices, the photovoltaic panels supported by the panel support floating devices being provided full, the full portions of the photovoltaic panels extending above said interspaces.

39. The installation according to claim 36, wherein the connecting modules are floating, in whole or in part.

40. A method for manufacturing equipment according to claim 21 or also an a floating photovoltaic installation resulting from an assembly of said equipment, wherein:
said structural modules and said float modules are assembled in order to produce a floating network of photovoltaic panel support devices, the structural modules being supported by the float modules, the structure ensuring the transmission of the forces of the floating network of the photovoltaic panel support devices resulting from the assembly of structural modules, directly together, and/or by way of connecting modules,
the assembly of the lugs facing one another is obtained, in whole or in part, by inserting the neck through the lugs, the stopper ensuring the locking of the assembly, the lugs being maintained between two abutments formed by said shoulder at the base of the neck and said shoulder of the stopper,
wherein the float modules are manufactured by blown injection or also by blown extrusion.
